(19) United States
(12) Patent Application Publication
(10) Pub. No.: US 2006/0053042 A1
(43) Pub. Date: Mar. 9, 2006

(54) Material distribution system, material distribution method and computer program product

(75) Inventors: Tomonari Yoshimura, Kyoto-shi (JP); Yoshikazu Ikenoue, Itami-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/002,799

(22) Filed: Dec. 3, 2004

(30) Foreign Application Priority Data
Sep. 3, 2004 (JP) 2004-257619

(51) Int. Cl. G05B 19/418

(52) U.S. Cl. 705/8

(57) ABSTRACT

A material distribution apparatus includes a storage area for storing materials, a storage area for storing conference schedule information that indicates persons to whom the material is permissible to be distributed, a user ID input portion for entering a user ID of a person who wants the material, a distribution permission decision portion for deciding whether the material is permissible or not to be distributed to the person who wants the material by comparing the entered user ID with the conference schedule information, and a material print control portion for printing the material on paper when it is decided that the material is permissible to be distributed.

This application is based on Japanese Patent Application No. 2004-257619 filed on Sep. 3, 2004, the contents of which are hereby incorporated by reference.

### BACKGROUND OF THE INVENTION

1. Field of the Invention

The present invention relates to a system and a method for distributing materials to people who gather at a specific place.

2. Description of the Prior Art

At an assembly such as a meeting, a lecture, a class, an exhibition, a presentation meting, or a recital, people gather at a specific place and materials are usually distributed to people. Conventionally, a host or hostess of an assembly has to predict the number of people who will gather to the assembly for distributing materials and prepare copies of the materials for the number by printing. This preparation is a large burden on the host or the hostess.

In order to solve this problem, a method is proposed as described in Japanese unexamined patent publication No. 2000-137653, in which when people who are invited to a meeting answer about their intention of attending the meeting or not, the number of materials for the meeting is adjusted in accordance with their answer about their intention.

Other some methods are also proposed for supporting an assembly such as a meeting. For example, Japanese unexamined patent publication No. 2003-140855 discloses a method of distributing unprinted data automatically to a predetermined terminal before starting a print operation or during a print operation, or distributing unprinted data automatically during a teleconference to a terminal of a person who left the teleconference about the contents after his or her leaving. Furthermore, Japanese unexamined patent publication No. 2002-125210 discloses a method of enabling to know readily about members who attended a meeting in a communication conference system such as a video conference system.

However, in the conventional method disclosed in Japanese unexamined patent publication No. 2000-137653, materials are printed in accordance with answers from people about their intention of attending or not. Therefore, the number of people who really attend the meeting may be smaller than the number of people who expressed their intention of attending, and the prepared materials may be too many. In another case, a larger number of materials may be prepared just in case than the number of people who expressed their intention of attending. In this way, materials are often remained that means a waste of paper resource in the conventional method.

Further in the conventional method, especially if there are plural materials, they have to be printed and organized in one group by picking up one by one material fairly before the date and time to start the assembly so as to facilitate distribution of the materials to people. Therefore, the host or hostess has to complete materials in good time.

Though it is possible to adopt the method of distributing materials by a network as described in Japanese unexamined patent publication No. 2003-140855, terminal devices and printers have to be disposed to members for the distribution, which needs a large scale of facilities. In addition, as the number of conferences to attend increases, the attendant has to prepare many materials, resulting in a large burden. Thus, there is a large burden on both a host or a hostess and an attendant.

### SUMMARY OF THE INVENTION

An object of the present invention is to reduce a waste of paper resource due to excessive number of copies when distributing materials for a conference. Another object of the present invention is to enable securing longer period for preparing materials. Still another object of the present invention is to facilitate distribution of materials.

A material distribution system according to the present invention includes a material storage portion for storing a material, a distribution target storage portion for storing distribution target information that indicates persons to whom the material is permissible to be distributed, a personal identification information input portion for entering personal identification information of a person who wants the material, a material distribution permission decision portion for deciding whether the material is permissible or not to be distributed to the person who wants the material by comparing the entered personal identification information of the person with the distribution target information, and a material output portion for outputting the material stored in the material storage portion for the person when it is decided that the material is permissible to be distributed to the person who wants the material.

The material distribution system is used especially for distributing materials to persons who attend assemblies. In this case, the material storage portion stores materials for each of the assemblies. The distribution target storage portion stores prospective attendant information that indicates persons who are scheduled to attend the assembly for each of the assemblies. The personal identification information input portion enters personal identification information of a person who visits the assembly. The material distribution permission decision portion decides whether the material for the assembly is permissible or not to be distributed to the person who visits the assembly by comparing the entered personal identification information of the person with the prospective attendant information of the assembly. The material output portion outputs the material stored in the material storage portion for the person when it is decided that the material for the assembly is permissible to be distributed to the person who visits the assembly. In this way, the material distribution system is structured.

In the present invention, “assembly” means an event where one or more people gather at a predetermined place in a predetermined period of time for a predetermined purpose. For example, a conference, a lecture, a class, an exhibition, a fair and a show are included in the assembly.

According to the present invention, a material for a conference or the like can be distributed only to persons who need the material, so that waste of paper resource can be reduced. In addition, it is possible to secure longer period for preparing materials. It is also possible to facilitate distribution of materials.

### BRIEF DESCRIPTION OF THE DRAWINGS

FIG. 1 is a diagram showing an example of an overall structure of an assembly support system.

FIG. 2 is a diagram showing an example of a hardware structure of a material distribution apparatus.

FIG. 3 is a diagram showing an example of a functional structure of the material distribution apparatus.

FIG. 4 is a diagram showing an example of data that are stored in boxes.

FIG. 5 is a table showing an example of a user information master.

FIG. 6 is a table showing an example of a conference information master.

FIG. 7 is a diagram showing an example of a material management setting screen.

FIG. 8 is a table showing an example of a distribution result information table.

FIG. 9 is a table showing an example of search condition information.

FIG. 10 is a flowchart showing an example of a process for searching conference information.

FIG. 11 is a diagram showing an example of an extracted conference screen.

FIG. 12 is a diagram showing an example of an initial state of a material selection screen.

FIG. 13 is a diagram showing an example of a button selection in the material selection screen.

FIG. 14 is a diagram showing an example of a material selection screen after outputting materials.

FIG. 15 is a flowchart for explaining an example of a process for updating attendant information.

FIG. 16 is a diagram showing an example of a search condition setting screen.

FIG. 17 is a flowchart for explaining an example of a prenotification process.

FIG. 18 is a flowchart for explaining a post-erasing process.

FIG. 19 is a flowchart for explaining a general flow of the material distribution apparatus.

### DESCRIPTION OF THE PREFERRED EMBODIMENTS

Hereinafter, the present invention will be explained more in detail with reference to embodiments and drawings.

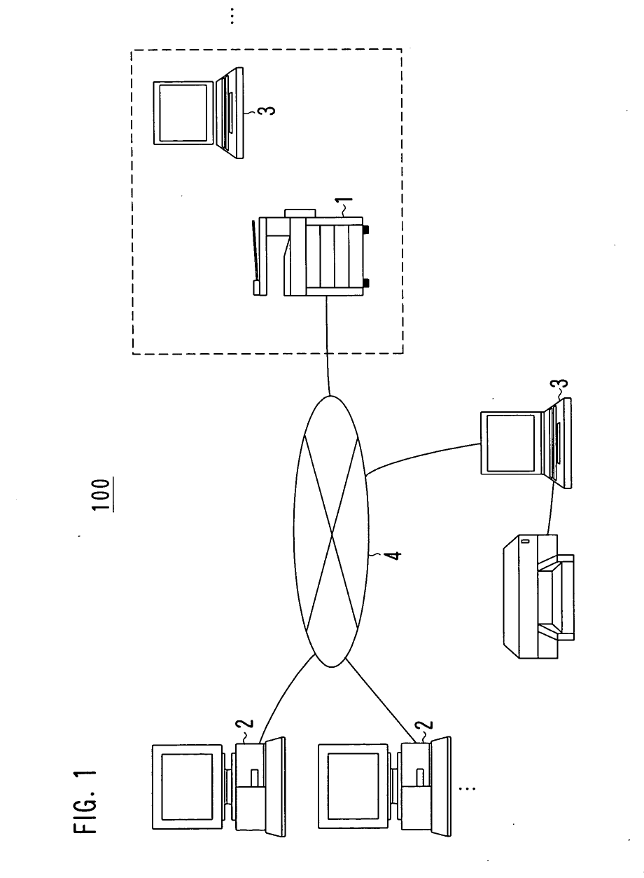

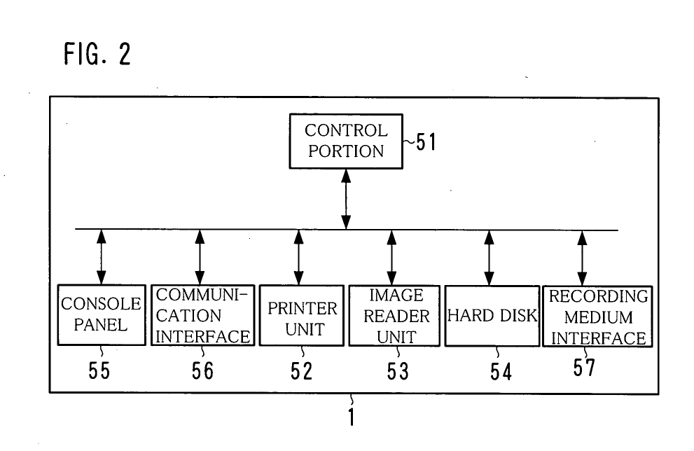

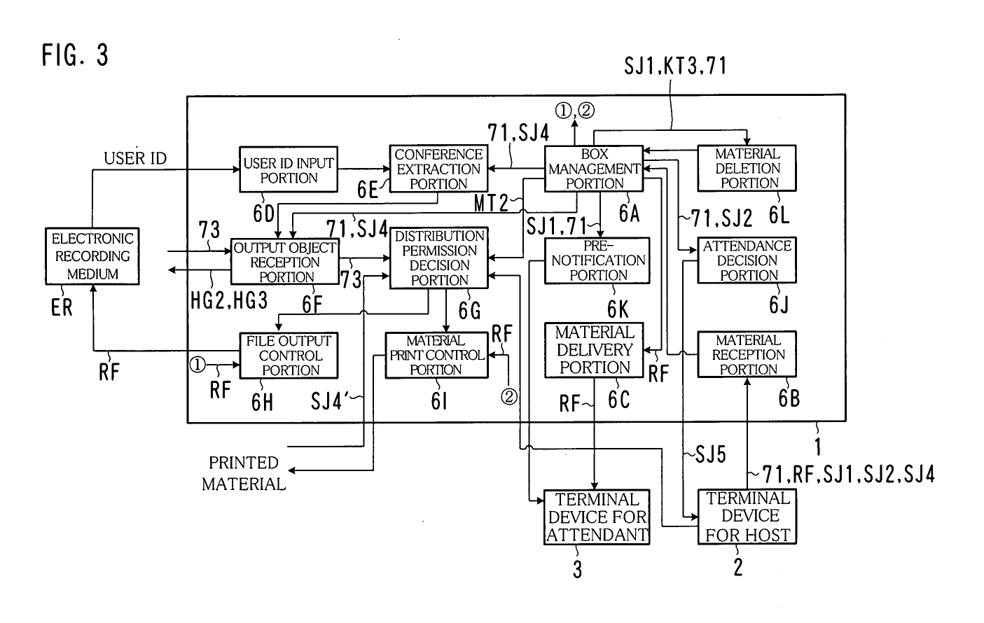

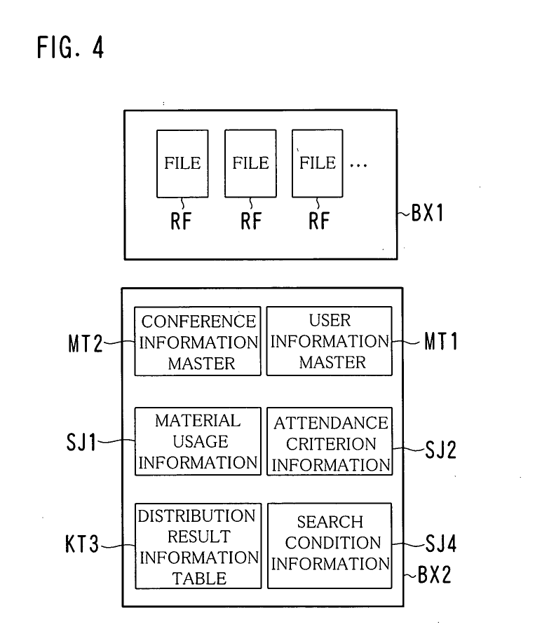

FIG. 1 is a diagram showing an example of an overall structure of an assembly support system 100, FIG. 2 is a diagram showing an example of a hardware structure of a material distribution apparatus 1, FIG. 3 is a diagram showing an example of a functional structure of the material distribution apparatus 1, and FIG. 4 is a diagram showing an example of data that are stored in boxes BX1 and BX2.

As shown in FIG. 1, the assembly support system 100 includes the material distribution apparatus 1 according to the present invention, a terminal device 2 for a host, a terminal device 3 for an attendant, and a communication line 4. The assembly support system 100 is used for supporting an assembly such as a conference, a lecture, a class, an exhibition, a fair and a show, in which people gather at a specific place. In particular, according to the assembly support system 100 of this embodiment, a material that is used for the assembly or supplements an explanation can be distributed to persons who visit the assembly.

Hereinafter, an example case is explained where the assembly support system 100 is used for distributing a material of a conference in a certain company X. Thus company X has a plurality of buildings in one site, and each of the buildings has one or more conference rooms.

One material distribution apparatus 1 is installed basically for one conference room. However, it is possible that plural conference rooms share one or more material distribution apparatuses 1. For example, if three conference rooms are arranged on the same floor of the same building like “conference room A”, “conference room B” and “conference room C”, one material distribution apparatus 1 may be placed in front of the conference room A, and the material distribution apparatus 1 may be shared by the conference rooms A, B and C. Alternatively, one or more material distribution apparatuses 1 may be placed in a lobby of the building, and the material distribution apparatuses 1 may be shared by all conference rooms in the building.

The material distribution apparatus 1 can be an image forming device having integrated functions of a copying machine, a printer, a scanner, a FAX and a document server. Such an image forming device may be called a multifunction device or a multifunction peripheral (MFP).

The terminal device for the host 2 is provided to each of departments of the company X, and it is used for preparing materials for a conference. The terminal device for the attendant 3 is used by employees of the company X for commercial use. A terminal device such as a personal computer, a workstation, a personal digital assistant (PDA), a cellular phone or the like can be used as the terminal device for the host 2 and the terminal device for the attendant 3. Especially, it is desirable that the terminal device for the attendant 3 be a portable terminal device like a notebook-sized personal computer or a PDA. It is possible to use one terminal device as both the terminal device for the host 2 and the terminal device for the attendant 3.

The material distribution apparatus 1, the terminal device for the host 2 and the terminal device for the attendant 3 are connected with each other via the communication line 4. An intranet, the Internet, a private line or a public telephone line can be used as the communication line 4.

The material distribution apparatus 1 includes a control portion 51, a printer unit 52, an image reader unit 53, a hard disk 54, a console panel 55, a communication interface 56 and a recording medium interface 57 as shown in FIG. 2.

The control portion 51 includes a circuit or the like for controlling the CPU, the RAM, the ROM and other portions of the material distribution apparatus 1. The printer unit 12 is a laser type device or an ink jet type device that prints an image on a predetermined sheet of paper in accordance with print data. The image reader unit 13 is a scanner device that includes an original glass table, an image sensor such as a CCD and an automatic document feeder for reading original images optically and converting the images into electronic data so as to generate image data.

Programs and data are installed in the hard disk 54 so as to realize functions of a box management portion 6A, a material reception portion 6B, a material delivery portion 6C, a user ID input portion 6D, a conference extraction portion 6E, an output object reception portion 6F, a distribution permission decision portion 6G, a file output control portion 6H, a material print control portion 6I, an attendance decision portion 6J, a prenotification portion 6K and a material deletion portion 6L as shown in FIG. 3. These programs or data are loaded onto the RAM of the control portion 51 if necessary so that the CPU executes the programs. Thus, the portions of the material distribution apparatus 1 shown in FIG. 2 are controlled. The whole or a part of the program may be stored in a ROM or a nonvolatile memory. Alternatively, a part or the whole of the functions of the portions shown in FIG. 3 may be realized by a processor (a control circuit).

Furthermore, the hard disk 54 is provided with a box BX1 for storing data of materials for conferences and a box BX2 for storing various setting information as shown in FIG. 4. The “box” means a storage area corresponding to a “folder” or a “directory” in a personal computer or the like. Contents of data that are stored in the boxes BX1 and BX2 will be described later.

The console panel 55 is a user interface (UI) for a user of the material distribution apparatus 1 and includes a liquid crystal display and an operation portion. The liquid crystal display displays an operation screen or a setting screen. The operation portion includes keys or buttons including a numeric keypad and a start button. A touch panel can be used as the console panel 55.

The communication interface 56 is an interface for sending and receiving data to/from the terminal device for the host 2 and the terminal device for the attendant 3 via the communication line 4. A network interface card (NIC), a modem, a wireless LAN device or a terminal adapter (TA) can be used as the communication interface 56.

The recording medium interface 57 is a device for writing data into a removable and compact electronic recording medium ER or reading data out of the electronic recording medium ER. A USB (Universal Serial Bus) flash memory, an SD (Secure Digital) memory, a CF (Compact Flash), a flexible disk, a magneto optical disk (MO), an IC (Integrated Circuit) card or a voice memory can be used as the electronic recording medium ER. A device that supports the electronic recording medium ER is used as the recording medium interface 57. For example, if a USB flash memory is used as the electronic recording medium ER, a USB interface is used as the recording medium interface 57. If an IC card is used as the electronic recording medium ER, an IC tag reader/writer is used as the recording medium interface 57. Alternatively, it is possible to download directly to a memory or a hard disk of the terminal device carried by the attendant without using these recording media.

One electronic recording medium ER is provided to a user (to an executive or an employee) in the company X. This electronic recording medium ER stores a user ID of its owner who is a user. In addition, it has a storage area for storing electronic data for materials for a conference and individual search condition information SJ4′ that will be described later.

Next, processes performed by the portions of the material distribution apparatus 1 shown in FIG. 3, the terminal device for the host 2 and the terminal device for the attendant 3 will be described by dividing them roughly into processes for preparing the conference and processes to be performed after users visit the conference room.

[Processes for Preparing the Conference]

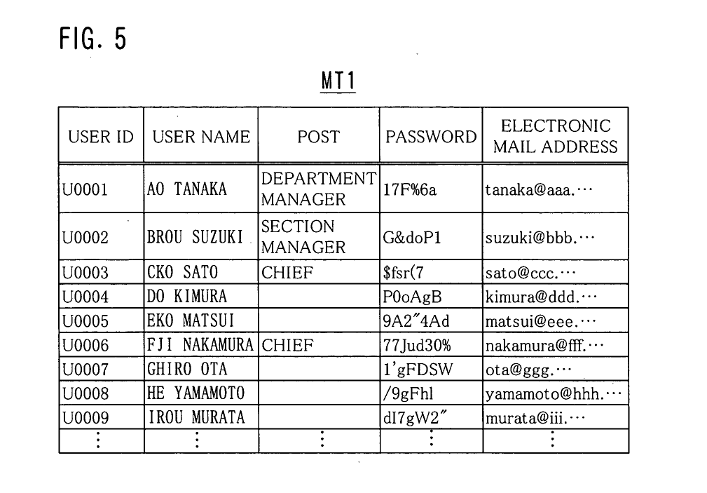

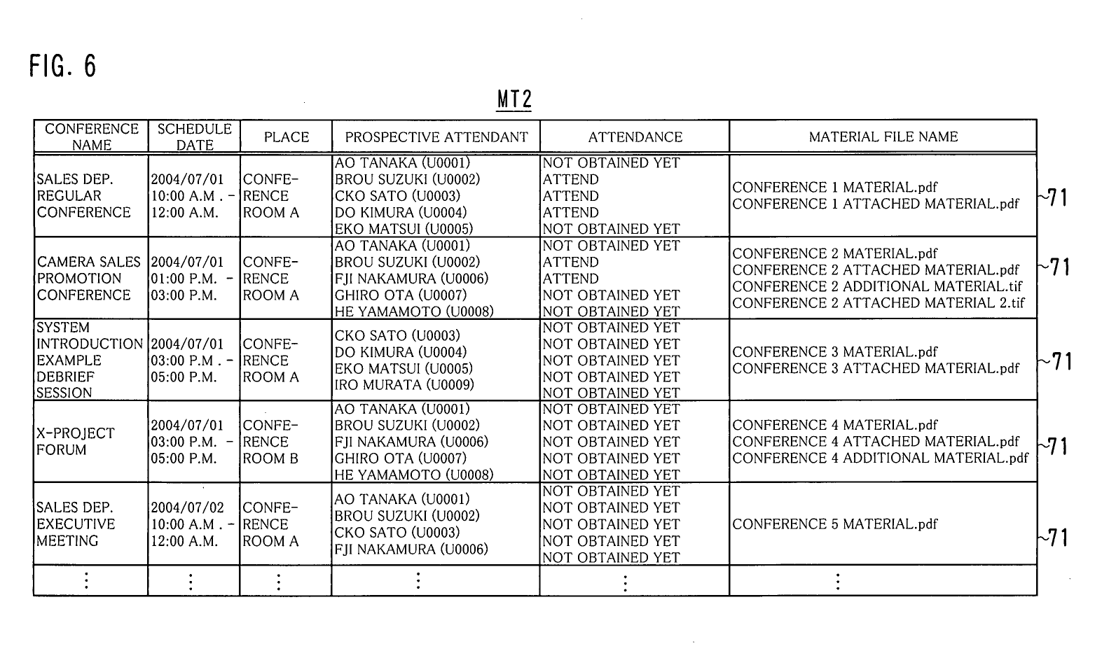

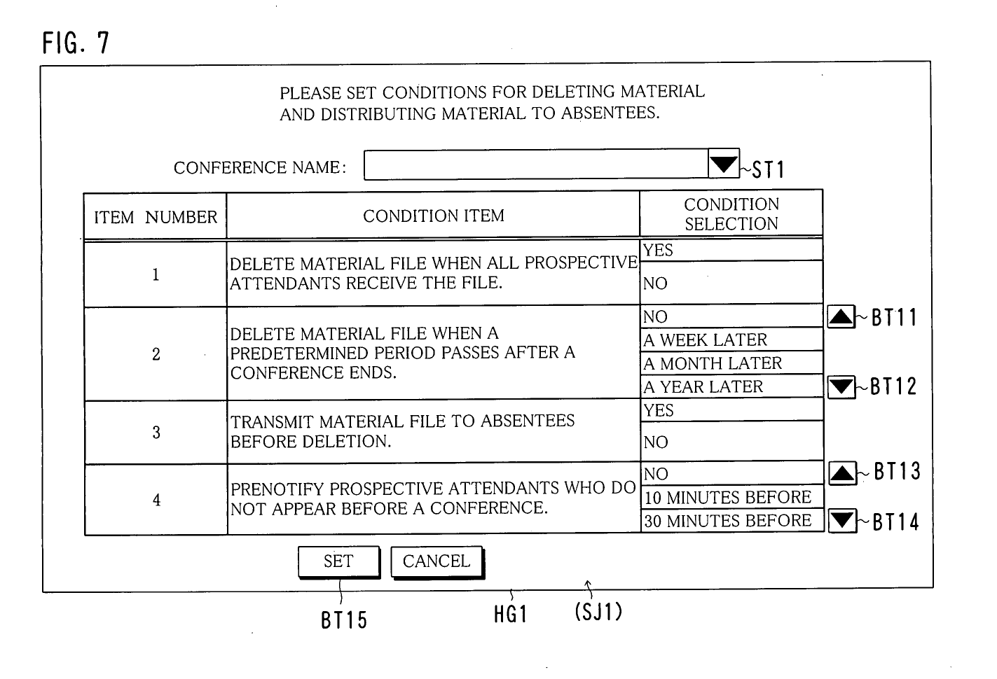

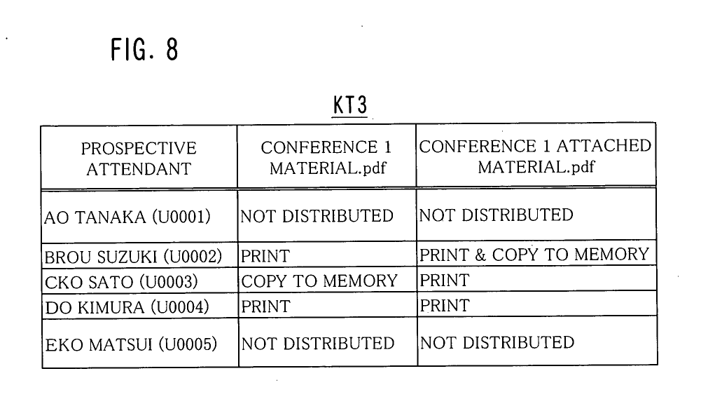

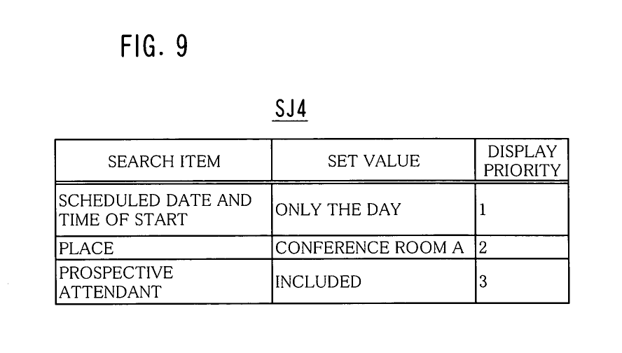

FIG. 5 is a table showing an example of a user information master MT1, FIG. 6 is a table showing an example of a conference information master MT2, FIG. 7 is a diagram showing an example of a material management setting screen HG1, FIG. 8 is a table showing an example of a distribution result information table KT3, and FIG. 9 is a table showing an example of search condition information SJ4.

The box management portion 6A shown in FIG. 3 manages data stored in the boxes BX1 and BX2 as shown in FIG. 4 and adds new data to the boxes BX1 and BX2 as management about boxes.

The box BX1 stores data of materials for conferences as files. Hereinafter, such a file is referred to as a “MATERIAL FILE RF”. The box BX2 stores a user information master MT1, a conference information master MT2, material usage information SJ1, attendance criterion information SJ2, a distribution result information table KT3 and search condition information SJ4.

The user information master MT1 stores information about users who belong to the company X (executives or employees) as shown in FIG. 5. One record is assigned to one user. A user ID for identifying a user is stored in a field of “USER ID”. An employee's number may be used as the user ID, for example. A name and a post name of the user are stored in fields of “USER NAME” and “POST”, respectively. A field of “PASSWORD” stores a password that is entered if necessary for confirming the user before the user starts using the material distribution apparatus 1. A field of “ELECTRONIC MAIL ADDRESS” stores an electronic mail address that the user sets in his or her terminal device for the attendant 3.

The conference information master MT2 stores information about conference that will be held in the company X as shown in FIG. 6. One record is assigned to one conference. A field of “CONFERENCE NAME” stores a name of the conference. A field of “SCHEDULE DATE” stores a date and time when the conference is scheduled to start and a date and time when the conference is scheduled to end (namely, a period during which the conference is scheduled to be held). A field of “PLACE” stores a name of the place where the conference is scheduled to be held (such as a name of a conference room). A field of “PROSPECTIVE ATTENDANT” stores user names and user IDs of members who are scheduled to attend the conference. A field of “ATTENDANCE” stores a value that indicates whether or not the member of the “PROSPECTIVE ATTENDANT” attended the conference. Meaning of the values stored in this field will be described later. A field of “MATERIAL FILE NAME” stores a file name of the material file RF of the material for the conference. Other than that, each record is provided with a field for storing information that indicates a host of the conference.

The process for storing the material file RF in the box BX1 and registering information about the conference in the conference information master MT2 is performed in the following procedure, for example.

The host of the conference prepares data of texts, photographs, charts, illustrations or the like and produces materials that are used for the conference or materials for supplemental use by using application software installed in the terminal device for the host 2. Data of the produced material are stored temporarily as a material file RF of a file format that is supported by the material distribution apparatus 1 in the terminal device for the host 2. It is possible to prepare a plurality of material files RF for one conference. In addition, the host enters a period of the conference, a place of the conference, members that are scheduled for the conference, a file name of the produced material and a name of the host and others are entered as conference schedule information 71 in the terminal device for the host 2. When the host enters a predetermined command, the terminal device for the host 2 sends the material file RF and the conference schedule information 71 to the material distribution apparatus 1.

When the material reception portion 6B of the material distribution apparatus 1 shown in FIG. 3 receives the material file RF and the conference schedule information 71, the box management portion 6A makes the material file RF be stored in the box BX1. Furthermore, a new record is generated in the conference information master MT2, and contents of the conference schedule information 71 are stored in a predetermined field.

Contents of the user information master MT1 shown in FIG. 5 are entered by a person in charge of personnel in the company X or an administrator of the assembly support system 100. In addition, they are updated if necessary when a personnel change such as transfer, promotion, resign or entrance of a new employee user.

The material usage information SJ1 shown in FIG. 4 is information about a usage method of the material for the conference and is stored in the box BX2 by the following manner, for example.

The host of the conference operates the terminal device for the host 2 for sending a predetermined command to the material distribution apparatus 1. Then, screen information corresponding to the command is sent from the material distribution apparatus 1 so that the terminal device for the host 2 displays the material management setting screen HG1 as shown in FIG. 7.

Here, the host performs setting of usage of the material for the conference as below. When pressing a drop down list ST1, a list of conference names of conferences is displayed, which will be held by the host among conferences managed in the conference information master MT2 shown in FIG. 6. Then, a conference name of the conference that is an object of setting is selected.

In order to select deletion of the material file RF when all the prospective attendants of the conference receive distribution of material, its selection is performed by pressing the “YES” area in the line having the item number “1” in the material management setting screen HG1. If it is not necessary for the deletion that all the prospective attendants receive the distribution of material, the “NO” area is selected.

In order to select deletion of the material file RF when a predetermined period passes after the conference ends even if all or part of the prospective attendants do not receive the distribution of material, an area corresponding to the predetermined period in the line having the item number “2” is selected. For example, in order to delete the material file RF when a week after the conference ends, the “A WEEK LATER” area is selected. Note that depending on a size of the screen, there is a case where all options do not appear in the material management setting screen HG1. In this case, the host can see other options by pressing an upward scroll button BT11 or a downward scroll button BT12 to scroll the area for selecting conditions upward or downward.

In order to select automatic transmission of the material file RF of the material for the conference to absentees of the conference before the material file RF is deleted, the “YES” area in the line having the item number “3” is selected. In order to select non-transmission automatically, the “NO” area is selected.

In order to select to send a notice of starting the conference soon to prospective attendants who do not appear in the conference room a predetermined time before the scheduled date and time of the conference, the area corresponding to the predetermined time in the line having the item number “4” is selected. For example, in order to send the notice 10 minutes before, the area of “10 MINUTES BEFORE” is selected. Similarly to the case of setting the item number “2”, it is possible to use the upward scroll button BT13 or the downward scroll button BT14 for making other options be displayed for selection.

Then, after completing the selection for the conference name and the items “1”-“4”, the host presses the setting button BT15. Then, terminal device for the host 2 sends the contents selected in the material management setting screen HG1 as the material usage information SJ1 to the material distribution apparatus 1.

In the material distribution apparatus 1, the material reception portion 6B shown in FIG. 3 receives the material usage information SJ1, and the box management portion 6A stores the material usage information SJ1 in the box BX2 shown in FIG. 4.

The attendance criterion information SJ2 shown in FIG. 4 indicates a decision criterion about attendance to the conference. This attendance criterion information SJ2 is set similarly to the material usage information SJ1 in the terminal device for the host 2 of the host of the conference as described below.

The host of the conference enters a predetermined command for displaying a predetermined screen on the terminal device for the host 2. While seeing the screen, the host selects a conference name of the conference that is an object of setting and designates by when the prospective attendant has to appear in the conference room for being regarded to attend the conference. For example, in order to permit delay a little time, it is designated like “IN TEN MINUTES AFTER THE SCHEDULED DATE AND TIME”, for example. If any delay is not permitted, it is designated like “BEFORE THE SCHEDULED DATE AND TIME”. The terminal device for the host 2 sends the contents selected or designated in this way as the attendance criterion information SJ2 to the material distribution apparatus 1. Then, the box management portion 6A stores the attendance criterion information SJ2 in the box BX2. In addition, if there is a plurality of subjects in one conference, it is possible to designate that the user can register a schedule to attend only a time slot of the subject in which he or she is interested.

The distribution result information table KT3 is provided one for each conference for indicating a state of distribution of materials for the conference as shown in FIG. 8. This distribution result information table KT3 is generated when new information (record) about the conference is registered in the conference information master MT2. In addition, if an addition, a deletion or a change of file name or a change of prospective attendants is made to material file RF of the material after that, a structure of the distribution result information table KT3 is changed. Note that an initial value of each field in each record included in the distribution result information table KT3 is “NOT DISTRIBUTED”. Detailed contents of the distribution result information table KT3 will be described later.

The search condition information SJ4 indicates conditions for a user who visits the conference room searches information of the conference to attend by the material distribution apparatus 1 and has contents as shown in FIG. 9. This search condition information SJ4 is set by a person in charge of personnel in the company X or an administrator of the material distribution apparatus 1 in advance for each material distribution apparatus 1 as described below, for example.

In order to select permission of distribution of the material when the user appears in the conference room late but within an hour after the start time, the value of “SCHEDULED DATE AND TIME OF START” is set to “WITHIN ONE HOUR”. In order to select permission of distribution of the material when the user appears in the conference room during the day when the conference is held, it is set to “THE DAY”. If the preparation of the material is scheduled to finish just before the start time (for example, the preparation of the material is scheduled to finish one hour before the scheduled date and time of the start) though the distribution of the material is permitted to a user who appears in the conference late but within an hour after the start time, it is set to “BEFORE ONE HOUR-AFTER ONE HOUR”. If the time of distribution doesn't care, it is set to “NOT CARE”.

The value of “PLACE” is preferably set to a conference room located within a range of a predetermined distance from the position where the material distribution apparatus 1 is placed. For example, if only the conference room D is located near the material distribution apparatus 1, the value of “PLACE” is set to “CONFERENCE ROOM D”. If there are conference rooms A, B and C on the floor where the material distribution apparatus 1 is placed, it is set to “CONFERENCE ROOMS A-C” or “CONFERENCE ROOMS ON THE SAME FLOOR”. Other than that, considering convenience of users and a cost for the facility, it can be set to “CONFERENCE ROOMS IN THE SAME BUILDING” or “CONFERENCE ROOMS IN THE SAME SITE”. In order to perform searching regardless of the position where the material distribution apparatus 1 is placed, it is set to “DON'T CARE”.

In order to make it possible that a user who visits the conference room searches only conferences that include the user as the prospective attendant, the value of “PROSPECTIVE ATTENDANT” is set to “INCLUDED”. If it doesn't care whether or not the user is included as the prospective attendant, the value is set to “DON'T CARE”.

It is possible to set the search condition information SJ4 not for each of the material distribution apparatuses 1 but for each of the conferences. Otherwise, it is possible to set it for each of the users as being explained later. Note that “DISPLAY PRIORITY” will be described later.

The material delivery portion 6C shown in FIG. 3 responds to a request from the user and performs a process for sending the material file RF of the material for the conference stored in the box BX1 shown in FIG. 4 to the terminal device for the attendant 3 of the user. Thus, the user can obtain and view the material in advance that is under preparation. Of course, the user can obtain a latest material after the conference finishes as long as it is stored in the box BX1.

Note that it is possible to respond to a request from only a user who is a prospective attendant of the conference or a predetermined user (for example, an executive above a predetermined class) because confidential information may be included in the material file RF. In this case, the user may be required to enter a user ID and a password for authentication of the user.

[Process after the User Visits the Conference Room]

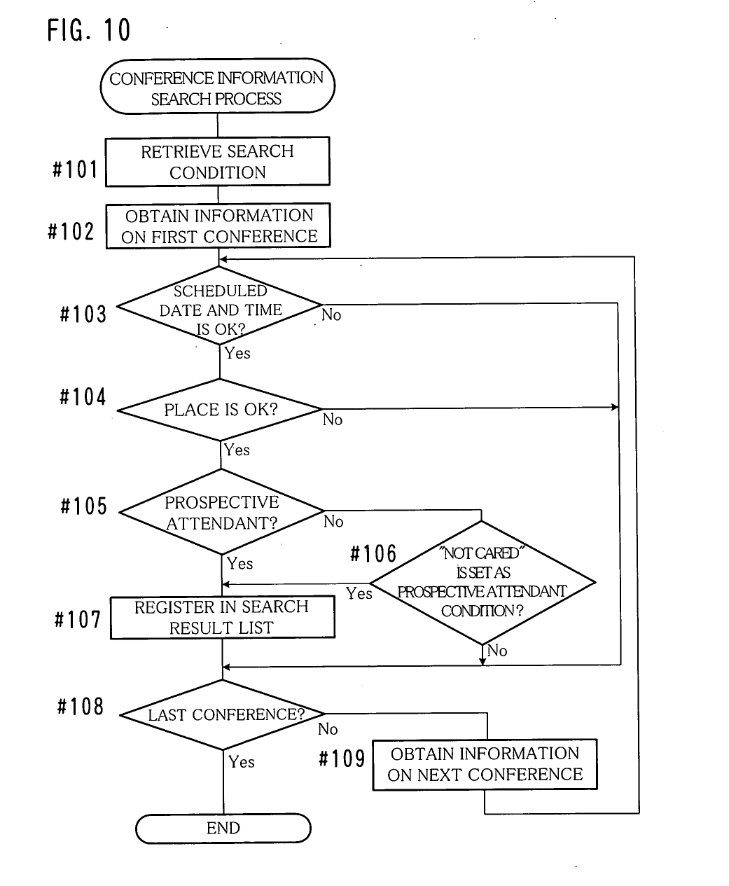

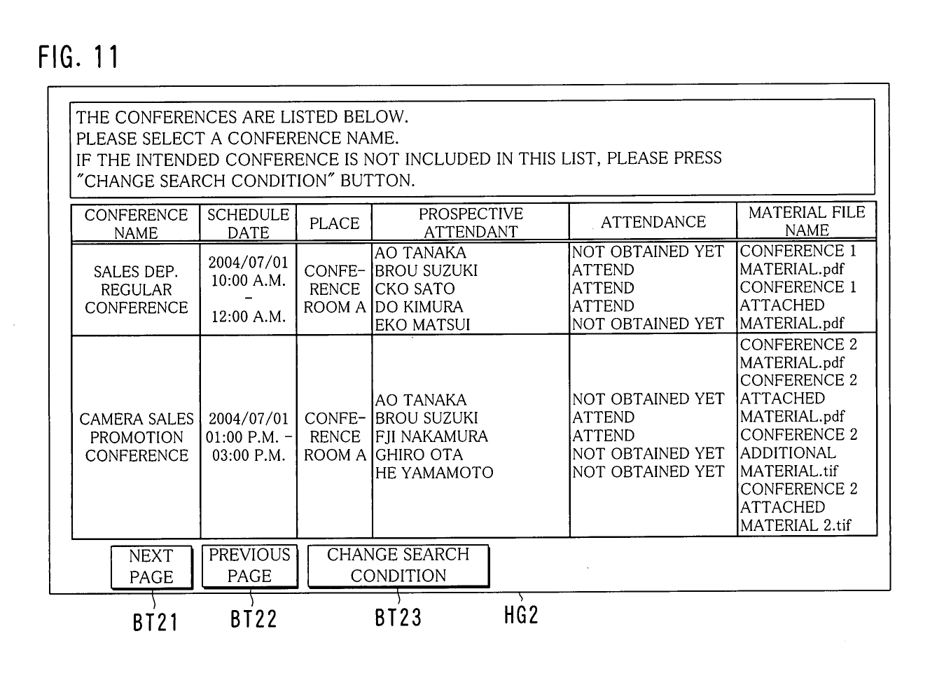

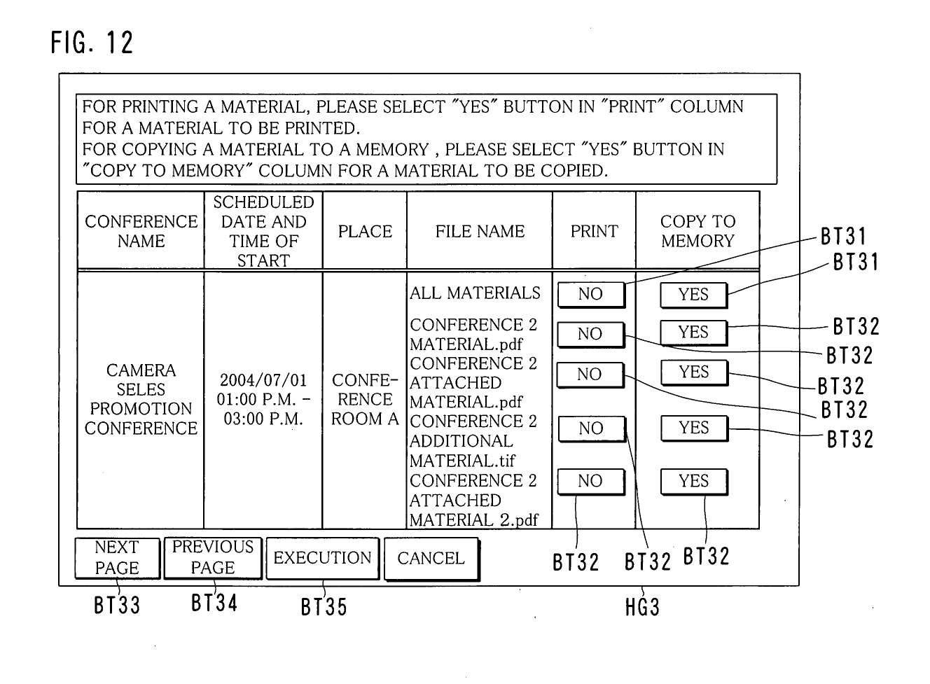

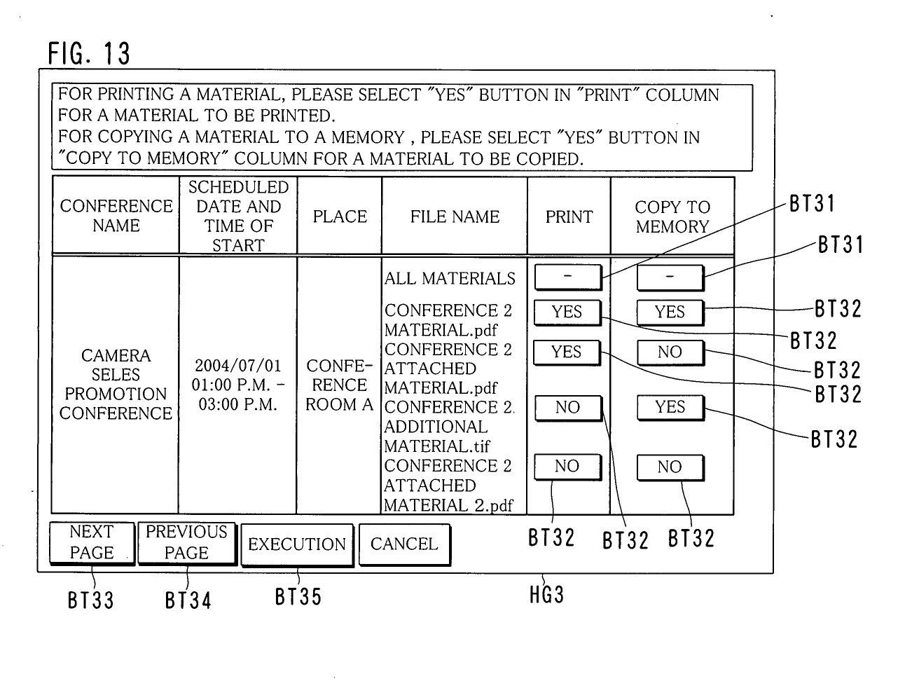

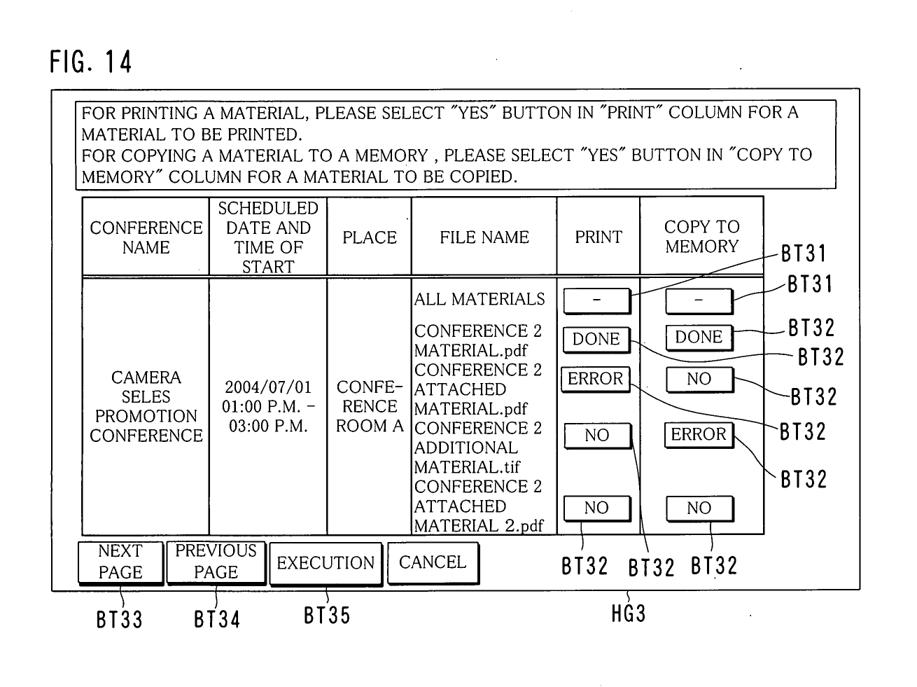

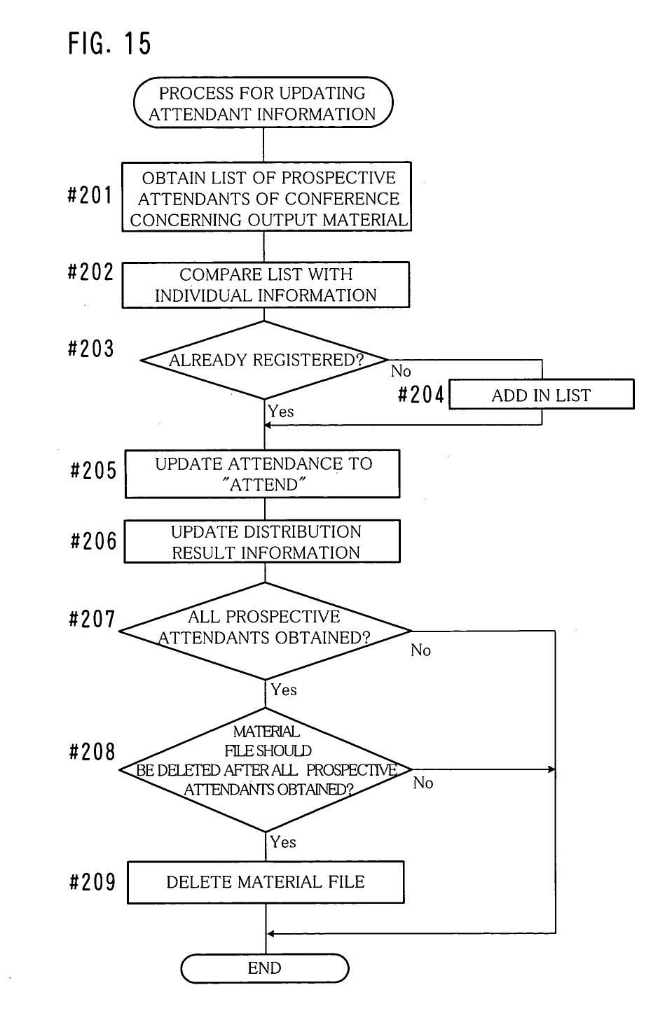

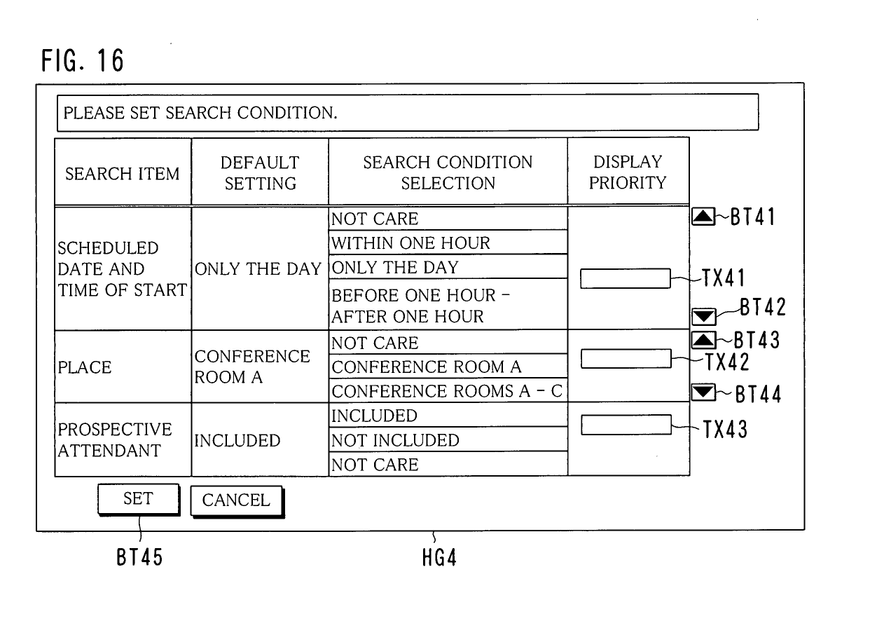

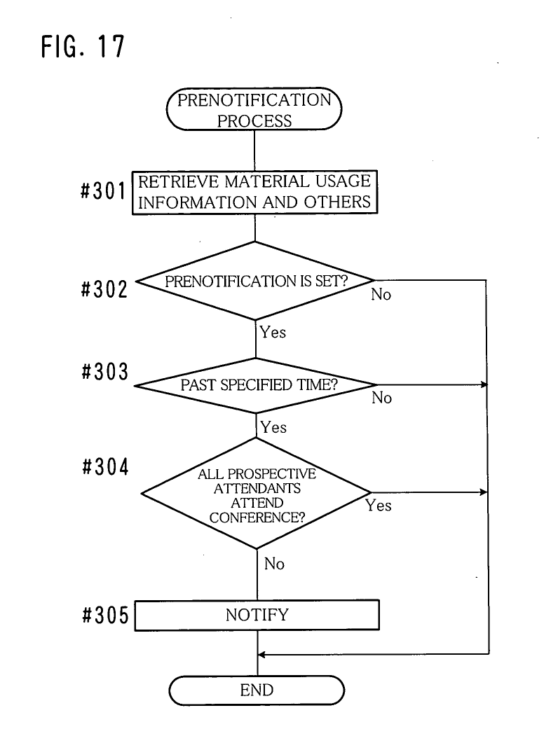

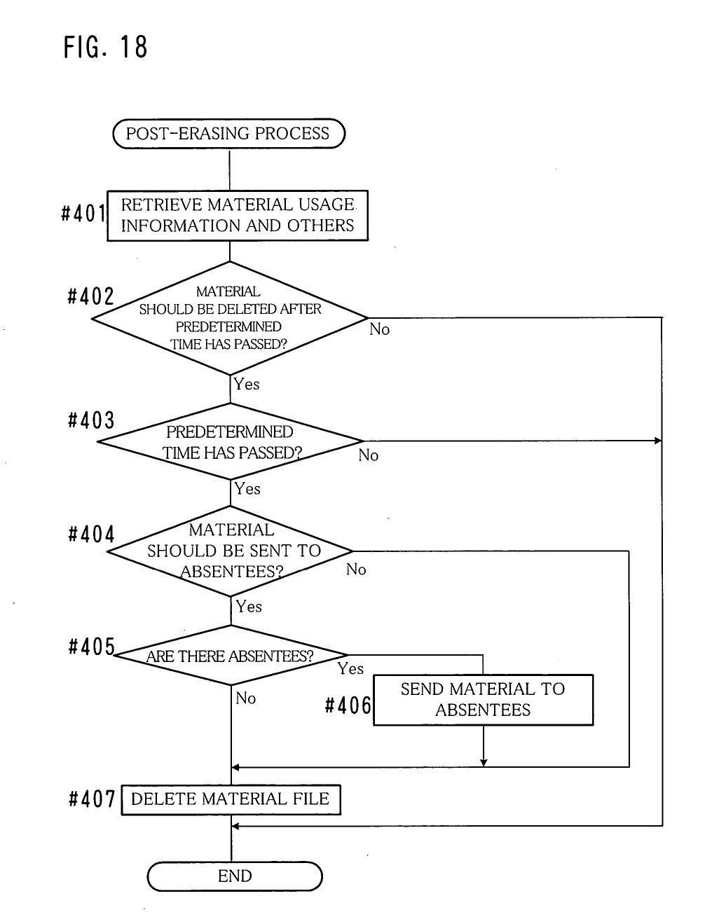

FIG. 10 is a flowchart showing an example of a process for searching conference information, FIG. 11 is a diagram showing an example of an extracted conference screen HG2, FIG. 12 is a diagram showing an example of an initial state of a material selection screen HG3, FIG. 13 is a diagram showing an example of a button selection in the material selection screen HG3, FIG. 14 is a diagram showing an example of a material selection screen HG3 after outputting materials, FIG. 15 is a flowchart for explaining an example of a process for updating attendant information, FIG. 16 is a diagram showing an example of a search condition setting screen HG4, FIG. 17 is a flowchart for explaining an example of a prenotification process, and FIG. 18 is a flowchart for explaining a post-erasing process.

When the user who is scheduled to attend a conference arrives at the place where the conference is held, the user sets his or her electronic recording medium ER to the recording medium interface 57 of the material distribution apparatus 1 that is placed at the location or neighborhood. Then, the user ID input portion 6D shown in FIG. 3 reads the user ID that is recorded in the set electronic recording medium ER and enters it in the material distribution apparatus 1.

The conference extraction portion 6E extract a conference that is assumed to be one that the user will attend from the conference information master MT2 (see FIG. 6) by a procedure shown in FIG. 10. First, the search condition information SJ4 (see FIG. 9) that is set in the material distribution apparatus 1 is retrieved from the box BX2 shown in FIG. 4 (#101 in FIG. 10). The conference schedule information 71 of the first conference is obtained from the conference information master MT2 (#102).

It is decided whether or not the scheduled date and time indicated in the “START DATE AND TIME” field in the conference schedule information 71 satisfies the condition of the scheduled start date and time indicated in the search condition information SJ4, and whether the conference room indicated in the “PLACE” field in the conference schedule information 71 satisfies the condition of the place where the conference is held indicated in the search condition information SJ4 (#103, #104).

If at least one of the conditions is not satisfied (No in #103 or No in #104), the conference schedule information 71 that is stored in the next line is obtained from the conference information master MT2 (#109), so that the process after the step #103 is repeated based on the obtained conference schedule information 71. However, if the next conference schedule information 71 does not exist (Yes in #108), the process is finished.

If both the conditions are satisfied (Yes in #103 and Yes in #104), it is further decided whether or not the user is indicated in the “PROSPECTIVE ATTENDANT” field of the conference schedule information 71 (#105). If the user is included (Yes in #105), the conference of the conference schedule information 71 is extracted and is registered in the search result list (#107).

If it is not included (No in #105), it is checked whether or not the value “DON'T CARE” is set as the condition of the prospective attendant in the search condition information SJ4 (#106). If the value “DON'T CARE” is set (Yes in #106), a conference concerning the conference schedule information 71 is extracted regardless of the decision result in the step #105 and is registered in the search result list (#107). If the value “INCLUDED” is set as the condition of the prospective attendant (No in #106), the conference concerning the conference schedule information 71 is not registered in the search result list.

Then, the next conference schedule information 71 is obtained sequentially, and the process of the steps #103-#107 is repeated until the process is finished for the last conference schedule information 71 (No in #108, #109).

For example, it is supposed that the search condition information SJ4 has contents as shown in FIG. 9, and that the user ID entered by the user ID input portion 6D is “U0002”, and that the present date is Jul. 21, 2004. When the process of the flowchart shown in FIG. 10 is performed, the conferences having the conference names of “SALES DEP. REGULAR CONFERENCE” and “CAMERA SALES PROMOTION CONFERENCE” are extracted from the conference information master MT2 shown in FIG. 6.

Note that the console panel 55 displays a message like “A USB memory is set. Searching a material.” during the period after the electronic recording medium ER is set until the extraction process of conferences is finished.

With reference to FIG. 3 again, the output object reception portion 6F performs a process of accepting a designation of a material that a user who arrived at the conference room wants to output in the following procedure. First, the extracted conference screen HG2 as shown in FIG. 11 having a list of conferences (the search result list) extracted by the conference extraction portion 6E is displayed on the console panel 55.

If there are plural extracted conferences, they are sorted before being displayed in accordance with the setting of “DISPLAY PRIORITY” in the search condition information SJ4. For example, if the priority order of the display is set as shown in FIG. 9, they are sorted in the ascending order or the descending order of the “SCHEDULED START DATE AND TIME” having the display priority “1”. If there are plural conferences having the same scheduled start date and time, they are sorted in accordance with the order of the “PLACE” having the display priority “2” (for example, in the order of Japanese syllabary, the alphabetical order, or the ascending order of the distance to the place where the material distribution apparatus 1 is disposed). If there are plural conferences having the same scheduled start date and time and the same place where the conference is held, they are sorted in the order of “PROSPECTIVE ATTENDANT” (for example, in the order of Japanese syllabary, the alphabetical order, the order of user ID or the order of the post).

Note that all the extracted conferences may not be displayed at one time because of the limitation of the screen size. In this case, the user can press a next page button BT21 or a previous page button BT22 for changing the list so that all the extracted conferences can be viewed.

When the user presses and selects the line that includes the conference name of the conference that the user intends to attend among this list, the output object reception portion 6F displays the material selection screen HG3 having a list of materials for the conference as shown in FIG. 12.

The material selection screen HG3 includes an all selection button BT31 and an individual selection button BT32. In the initial state of the material selection screen HG3, a display of each of the all selection button BT31 and the individual selection button BT32 is “NO”. If the user wants all copies of the materials for the conference, the all selection button BT31 in the “PRINT” column should be pressed one time. Then, the display of the all selection button BT31 is changed to “YES”, and the display of the individual selection button BT32 in the “PRINT” column is also changed to “YES”. Note that when the all selection button BT31 is pressed again, the selection is canceled back to “NO”. Similarly, if the user wants electronic data of all materials (material files RF) for the conference, the all selection button BT31 in the “COPY TO MEMORY” column should be pressed one time for selection.

If the user wants to select to have a copy or electronic data for each material, the user should select the individual selection button BT32 in the “PRINT” column or the individual selection button BT32 in the “COPY TO MEMORY” column in the line of the file name of the material file RF for each material in accordance with his or her desire. For example, it is supposed that the user desires both a copy and electronic data of the material for “conference 2 material.pdf”, and desires only a copy of the material for “conference 2 attached material.pdf”, and desires only electronic data of the material for “conference 2 additional material.tif”, and does not need both a copy and electronic data of the material for “conference 2 attached material 2.pdf”. Then, each individual selection button BT32 should be selected so that the display becomes as shown in FIG. 13. Note that the display of the all selection button BT31 is changed to a hyphen “-” that indicates being void when the individual selection button BT32 is pressed for selecting the material.

After finishing the selection of the output method for the materials in this way, the user presses an execution button BT35. Then, the output object reception portion 6F accepts information that indicates the material selected in the material selection screen HG3 and the output method (whether it is delivered as a copy or electronic data) as output object information 73.

The distribution permission decision portion 6G decides whether the material indicated in the output object information 73 is permissible to be distributed to a user who wants the material by the following method, for example.

The conference information master MT2 shown in FIG. 6 is referred to, and it is checked whether or not the user is included in the prospective attendants of the conference for which the material is used. If the user is included, it is decided that the material is permissible to be distributed.

If the user is not included (namely, the user is not a prospective attendant), a screen is displayed for the user to answer whether the user has an intention to attend the conference for which the material is used. If the user answers to have the intention to attend the conference, it is inquired of the host of the conference by electronic mail for example whether or not the user is permissible to attend the conference. If an answer that the user is permissible to attend is sent from the terminal device for the host 2, it is decided that the material is permissible to be distributed to the user, and a message that indicates the decision is displayed on the console panel 55. It is possible to confirm that the user has a predetermined authority (for example, a predetermined post or a predetermined affiliation) for attending the conference by a password or the like and to decide that the material is permissible to be distributed after the confirmation instead of inquiring of the host.

If it is decided that the material is permissible to be distributed, the box management portion 6A registers the user newly in the conference information master MT2 shown in FIG. 6 and as a prospective attendant in the distribution result information table KT3 shown in FIG. 8. The file output control portion 6H retrieves the material file RF of the material that is indicated in the output object information 73 and that the user desires to obtain as electronic data from the box BX1, and copies the material file RF to the electronic recording medium ER that is set to the recording medium interface 57. The material print control portion 6I retrieves the material file RF of the material that is indicated in the output object information 73 and that the user desires to obtain as a copy from the box BX1, and prints the contents of the material on sheets of paper in accordance with the material file RF. The console panel 55 opens the material file RF of the material and displays the contents thereof. The user can use the material file RF that is copied to the electronic recording medium ER after going back to his or her desk, or can use it during the conference if the user carries the terminal device for the attendant 3 in the conference room.

On the other hand, if the answer that the user is permissible to attend the conference is not sent from the host, the distribution permission decision portion 6G decides that the material is not permissible to be distributed to the user, and a message indicating the decision is displayed on the console panel 55. The file output control portion 6H and the material print control portion 6I stop the process without delivering the material.

When the file output control portion 6H or the material print control portion 6I finishes the process, the display of the individual selection button BT32 is changed from “YES” to a value corresponding to the result of the process as shown in FIG. 14. Namely, the display of the individual selection button BT32 of the material that is succeeded in the output process is changed to “DONE”, while the display of the individual selection button BT32 of the material that is failed is changed to “ERROR”. The fail of the output process may be caused by out of paper, paper jamming or shortage of memory capacity. The user may remove these causes and do the operation again for obtaining the desired material.

The box management portion 6A updates the distribution result information table KT3 shown in FIG. 8 and the conference schedule information 71 in the conference information master MT2 shown in FIG. 6 in accordance with the result of the output process by the file output control portion 6H or the material print control portion 6I. In addition, the material deletion portion 6L deletes the material file RF of the delivered material if necessary. These processes are performed in the procedure shown in FIG. 15.

The conference schedule information 71 and the distribution result information table KT3 of the conference for which the delivered material is used are retrieved from the conference information master MT2 and the box BX2, respectively (#201 in FIG. 15). The “PROSPECTIVE ATTENDANT” of the retrieved conference schedule information 71 is compared with the user for whom the material is delivered (#202). As a result, if it is decided that the user is registered as the prospective attendant (Yes in #203), a value of “ATTENDANCE” in the conference schedule information 71 corresponding to the user is updated to “ATTEND” (#205). Furthermore, the field of the file name in the material file RF of the material corresponding to the user in the distribution result information table KT3 is updated as below (#206).

For example, it is supposed that a material “conference 1 material.pdf” of a conference “SALES DEP. REGULAR CONFERENCE” is delivered as a printed copy and a material “conference 1 attached material.pdf” is delivered as electronic data (a material file RF) to a user whose user ID is “U0001”. In this case, “conference 1 material.pdf” field and the “conference 1 attached material.pdf” field of the record of the user ID “U0001” are updated to values of “PRINT” and “COPY TO MEMORY”, respectively. Note that if both a copy and electronic data are delivered for one material, the value is updated to “PRINT & COPY TO MEMORY”.

On the other hand, if it is decided that the user is not registered as a prospective attendant (No in #203), the user is registered in “PROSPECTIVE ATTENDANT” of the conference schedule information 71 and the distribution result information table KT3 (#204), and then the process of the steps #205 and #206 described above is performed.

As a result of the process in the step #206, if the distribution result information table KT3 indicates that the material for the conference is distributed to all the prospective attendants (Yes in #207), and if it is set that the material file RF of the material is deleted when all the attendants obtain the material for the conference in the material usage information SJ1 (see FIG. 7) of the conference (Yes in #208), the material deletion portion 6L deletes the material file RF from the box BX1 shown in FIG. 4 (#209). Otherwise (No in #207 or No in #208), the material file RF is not deleted at least here.

It may happen that the conference that the user will attend cannot be found in the extracted conference screen HG2 shown in FIG. 11. In this case, the user can change the search condition that is preset in the material distribution apparatus 1 as below for making the conference extraction portion 6E perform the extraction of conference.

The user performs a predetermined operation for making the console panel 55 display the search condition setting screen HG4 as shown in FIG. 16. Here, how the user want to change contents of the condition about a scheduled date and time, a place and prospective attendants is selected from the “SEARCH CONDITION SELECTION” by pressing an area where contents of the condition is written. If the desired item is not found, the user can press the scroll buttons BT41-BT44 for scrolling the screen so as to search other options. The user enters display priority of each of the search items in the text boxes TX41-TX43.

When the selection and the input are finished, the user presses a setting button BT45. Then, the conference extraction portion 6E shown in FIG. 3 extracts the conferences again in accordance with contents of the search condition that is selected or entered in the search condition setting screen HG4 instead of the search condition information SJ4 that is preset in the material distribution apparatus 1. The output object reception portion 6F displays the extracted conference screen HG2 that indicates the re-extracted conferences on the console panel 55. Note that contents of the search condition selected in the search condition setting screen HG4 may be stored in the electronic recording medium ER of the user as the individual search condition information SJ4′. Then, when the user uses the material distribution apparatus 1, the next time and after, the individual search condition information SJ4′ may be read out of the electronic recording medium ER for searching conferences.

The attendance decision portion 6J decides the attendants and absentees of the conference in accordance with the attendance criterion information SJ2 after the conference starts as follows. At the time point when a predetermined time has passed, if the value “ATTENDANCE” in the conference schedule information 71 of the conference in the conference -information master MT2 shown in FIG. 6 is “ATTEND”, the user (prospective attendant) is decided to be an attendant of the conference. If the value “ATTENDANCE” is still “NOT OBTAINED YET”, the user is decided to be an absentee. For example, if “IN 10 MINUTES AFTER THE SCHEDULED START DATE AND TIME” is set in the attendance criterion information SJ2, a person who arrives in 10 minutes after the scheduled start date and time and sets the electronic recording medium ER to the material distribution apparatus 1 is decided to be an attendant, while a person who sets after the time limit is decided to be an absentee. This decision result is sent as attendance record information SJ5 to the terminal device for the host 2 of the host of the conference. In addition, the value of “ATTENDANCE” of the user who is decided to be an absentee is updated to “ABSENCE”.

The prenotification portion 6K performs notification that it is close to the stat time of the conference (hereinafter referred to as a “prenotification”) to the prospective attendant who doesn't appear at the conference room a predetermined time before the scheduled start date and time of the conference in the procedure as shown in FIG. 17.

The material usage information SJ1 of the conference to be processed (see FIG. 7) is retrieved from the box BX2 shown in FIG. 4, and the conference schedule information 71 of the conference is retrieved from the conference information master MT2 (see FIG. 6) (#301 in FIG. 17). It is checked whether or not the material usage information SJ1 includes setting of prenotification to a prospective attendant who has not appear before starting the conference (#302). If the setting is included (Yes in #302), the time when the prenotification is to be performed is checked (#303).

Then, if the present date and time is past the time when the prenotification is to be performed (Yes in #303) and a user whose “ATTENDANCE” value is “NOT OBTAINED YET” is included in the “PROSPECTIVE ATTENDANT” (No in #304), the user information master MT1 shown in FIG. 5 is referred to, and electronic mail of the prenotification is sent to the electronic mail address of the user (#305). If it is before the time when the prenotification is to be performed (No in #303) or if all the users who are prospective attendants of the conference are regarded to have already arrived at the conference room (regarded to be attendants) (Yes in #304), the prenotification is not performed.

The material deletion portion 6L shown in FIG. 3 also deletes the material file RF of the material for the conference from the box BX1 shown in FIG. 4 in the case described above with reference to FIG. 15 as well as after the conference finished in the procedure as shown in FIG. 18.

The material usage information SJ1 (see FIG. 7) of the conference to be processed is retrieved from the box BX2, and the conference schedule information 71 of the conference is retrieved from the conference information master MT2 (see FIG. 6) (#401). If the material usage information SJ1 includes setting for deleting the material when a constant period has passed after the conference is finished (Yes in #402) and the constant period has already passed (Yes in #403), the material file RF of the material for the conference is deleted from the box BX1 (#407). However, if the material usage information SJ1 includes setting for sending the material to absentees before deleting the material (Yes in #404) and the value of “ATTENDANCE” in the conference schedule information 71 indicates that there is an absentee of the conference (Yes in #405), the user information master MT1 shown in FIG. 5 is referred to, and the material file RF is deleted (#407) after the material file RF is sent to the electronic mail address of the user who is the absentee (#406).

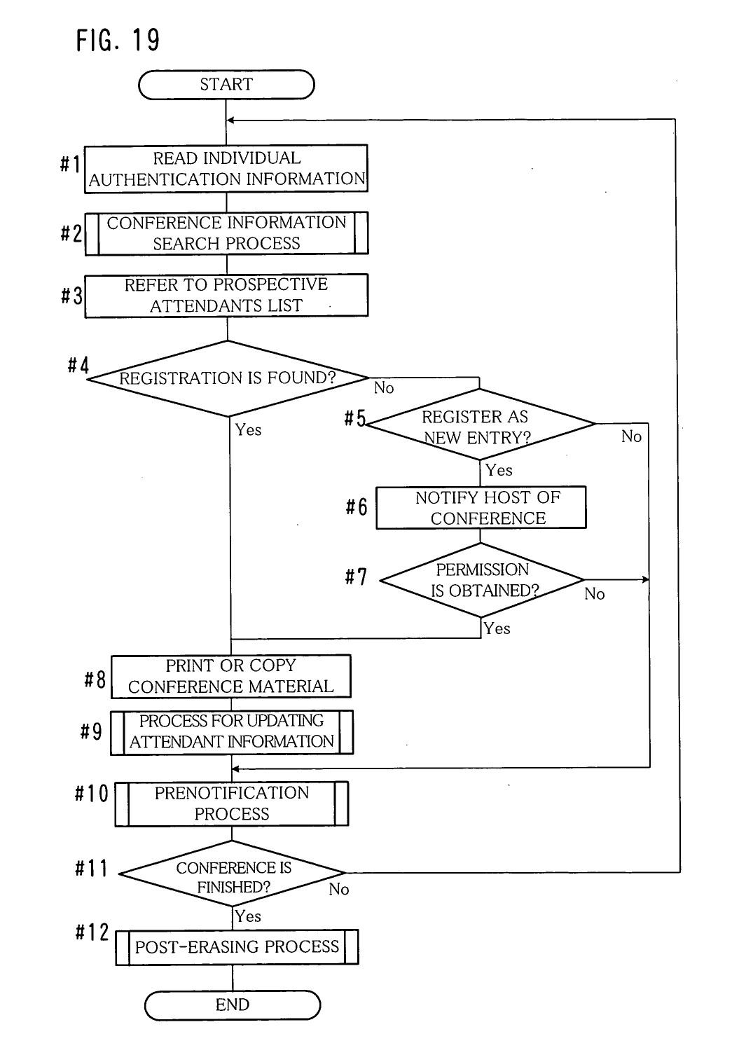

FIG. 19 is a flowchart for explaining a general flow of the material distribution apparatus 1. Next, a flow of a process performed by the material distribution apparatus 1 after a user visits a conference room for attending a conference until performing the process after the conference is finished with reference to the flowchart shown in FIG. 19.

When the user arrives at the conference room that is a place where the conference is held for attending the conference, the user sets his or her electronic recording medium ER to the material distribution apparatus 1 that is placed at the conference room or at a place close to there. Then, the material distribution apparatus 1 reads the user ID that is recorded on the electronic recording medium ER (#1 in FIG. 19), and searches a conference room of a conference that the user will attend in accordance with the user ID. The search result is displayed as the extracted conference screen HG2 shown in FIG. 11 (#2). The procedure for searching the conference room is already described above with reference to FIG. 10.

When the user selects a conference to be attended from the search result, and further selects the output method of the material for the conference, the material distribution apparatus 1 checks whether or not the user is a prospective attendant of the conference by referring to the conference information master MT2 shown in FIG. 6 (#3). If the user is a prospective attendant (Yes in #4), the material for the conference is delivered by the output method selected by the user and given to the user (#8).

If the user is not a prospective attendant (No in #4), the material distribution apparatus 1 inquires of the user whether the user has an intention of attending the conference (#5). If an operation for indicating the intention is performed (Yes in #5), it is inquired of the host of the conference whether the user is permissible to attend the conference (#6). Then, if the permission of attendance is obtained (Yes in #7), the material for the conference is delivered by the output method designated by the user (#8).

The information about the conference including the conference schedule information 71 and the distribution result information table KT3 is updated (#9). The procedure of this updating process is already described above with reference to FIG. 15.

During the period until the conference starts (#1-#9), the prenotification is performed for a user who has not come to the conference room yet (namely, a user whose electronic recording medium ER has not been read by the material distribution apparatus 1 yet) if necessary (#10). The procedure of this process is already described above with reference to FIG. 17.

When the conference is finished (Yes in #11), the material file RF of the material for the conference is deleted if necessary (#12). The procedure of this process is already described above with reference to FIG. 18.

According to this embodiment, printed copies of the material for the conference are distributed only to persons who actually come to the conference room. Therefore, it is possible to print just for the number of actual attendants so that waste of paper resource can be reduced compared to before. In addition, it is possible to secure a time period for preparing a material until the last minute when the conference starts because the material can be delivered by printing or the like for distributing to the prospective attendants at the timing when prospective attendants arrive at the conference room. Furthermore, if necessity of exchanging the material happened before the conference starts, it is not necessary to exchange the already printed material with a latest material like the conventional method. Therefore, waste of paper resource can be reduced, and the load of the host can be reduced.

In addition, attendants to a conference can be recognized and specified securely by distributing the material to users who visit the place where the conference is held and recording the distribution to users. In addition, the material is distributed only to attendants basically so that confidentiality of the material can be enhanced.

In addition, it is not necessary to provide a terminal device to each of the users unlike the conventional distribution of materials using a network, so the distribution of materials can be performed more readily than before.

Though the MFP is used as the material distribution apparatus 1 in this embodiment, a personal computer or a workstation (hereinafter referred to as “PC”) can be also used. In this case, a printer is connected to the PC. If it has no interface corresponding to the electronic recording medium ER, it is also connected to the PC. A program for realizing the portions described above with reference to FIG. 3 and a program for performing the process of the flowchart described above with reference to FIG. 19 are installed in the PC.

If the assembly support system 100 is used for other purpose than the conference, it is possible to structure it as below. For example, if it is used for distributing a material for a lecture in a school, a time slot while the material can be distributed may be set to a value like “the period from 20 minutes before the start of the lecture to 10 minutes after the start of the lecture”, and the criterion for regarding as attendance (attendance criterion information SJ2) may be set to a value like “the day and time when the electronic recording medium ER is set is the period from 20 minutes before the start of the lecture to 10 minutes after the start of the lecture”. Thus, it is prevented that a student gets attendances of plural lectures on the day at one time.

In another case such as an exhibition, the material distribution apparatus 1 may be provided to each of pavilions or booths. In the case of a large-scaled assembly, one material distribution apparatus 1 and a plurality of MFPs may be placed. The material distribution apparatus 1 performs management of material files RF and set information that are managed by the boxes BX1 and BX2 shown in FIG. 4. Each of the MFPs performs mainly a process for reading the user ID from the electronic recording medium ER of a visitor, a process for printing materials and a process for writing the material file RF into the electronic recording medium ER, while other processes are performed by the material distribution apparatus 1. Namely, the material distribution apparatus 1 works as a host machine or a server, while the MFP works as a terminal device.

After the conference is finished, data (a file) of the record of the conference may be stored in the box BX1, so that the file may be sent together with the material file RF of the material for the conference to absentees. The data of this record may be also sent to an attendant and a predetermined employee (a person who is in a predetermined post). A scribe may add items by handwriting during conference, and they may be entered by a scanner or a digital camera to be electronic data so as to be attached to the data of the record.

An electronic mail address may be used as information for identifying a user instead of the user ID. Alternatively, data of a finger print, a voice print or an iris of a user may be registered in the material distribution apparatus 1 instead of the user ID and the password, so that biometrics is used for deciding whether a person is a authorized user or not. An employee ID card or a conference attendance card may be used for such decision.

After the conference is finished and after the clean up process including deciding attendants and absentees and deleting the material file RF from the box BX1 is completed, the conference schedule information 71 of the conference may be deleted from the conference information master MT2 shown in FIG. 6.

It is possible to change or select the material to be distributed in accordance with an attribution of a user. For example, in the case of a user who attends regularly-held conferences, the previously distributed material or record may be distributed to the user when the user visits the conference being held this time.

Furthermore, a whole or a part of structure of the assembly support system 100, the material distribution apparatus 1, the terminal device for the host 2, the terminal device for the attendant 3, the contents of process, the order of the process, the structure of the setting information can be modified if necessary within the scope of the present invention.

Furthermore, this embodiment includes the following invention.

1. A material distribution system according to claim 1, further comprising a material deletion portion for deleting the material for the assembly from the material storage portion after a predetermined time has passed after the assembly started.

2. A material distribution system according to claim 5, further comprising a material deletion portion for deleting the material from the material storage portion after sending the material for the assembly to the terminal device of an absentee in the case where the attendance decision portion decides that there is an absentee for the assembly.

The present invention is used especially for performing a process of distributing materials for an assembly and confirming attendance or absence when holding an assembly such as a conference. A person who performs the present invention can sell a device or software to which the present invention is applied to a host who holds the assembly and can provide a service of establishing a system of the present invention in the existing system of the host.

What is claimed is:

1. A material distribution system comprising:
a material storage portion for storing a material;
a distribution target storage portion for storing distribution target information that indicates persons to whom the material is permissible to be distributed;
a personal identification information input portion for entering personal identification information of a person who wants the material;
a material distribution permission decision portion for deciding whether the material is permissible or not to be distributed to the person who wants the material by comparing the entered personal identification information of the person with the distribution target information; and
a material output portion for outputting the material stored in the material storage portion for the person when it is decided that the material is permissible to be distributed to the person who wants the material.

2. A material distribution system comprising:
a material storage portion for storing a material;
a distribution target storage portion for storing distribution target information that indicates persons who need the material;
a personal identification information input portion for entering personal identification information of a person who wants the material;
a material distribution permission decision portion for deciding whether the person needs the material or not by comparing the entered personal identification information of the person with the distribution target information; and
a material output portion for outputting the material stored in the material storage portion for the person when it is decided that the person needs the material.

3. A material distribution system for distributing a material to persons who attend an assembly, the system comprising:
a material storage portion for storing a material for each of assemblies;
a prospective attendant storage portion for storing prospective attendant information that indicates persons who are scheduled to attend the assembly for each of the assemblies;
a personal identification information input portion for entering personal identification information for identifying a person who visits the assembly;
a material distribution permission decision portion for deciding whether the material for the assembly is permissible or not to be distributed to the person who visits the assembly by comparing the entered personal identification information of the person with the prospective attendant information of the assembly; and
a material output portion for outputting the material stored in the material storage portion for the person when it is decided that the material for the assembly is permissible to be distributed to the person who visits the assembly.

4. The material distribution system according to claim 3, further comprising a schedule date storage portion for storing a schedule date for each of the assemblies, wherein
the material distribution permission decision portion decides that the material for the assembly is permissible to be distributed to the person who visits the assembly if the personal identification information of the person who visits the assembly is included in the prospective attendant information of the assembly and if present date and time belong to a predetermined time slot including the schedule date of the assembly.

5. The material distribution system according to claim 3, further comprising
a visitor storage portion for storing the personal identification information of a person who visits the assembly in connection with the assembly, the personal identification information being entered by the personal identification information input portion, and
an attendance decision portion for deciding whether each of the persons indicated in the prospective attendant information of the assembly attended the assembly or not after the assembly starts by checking whether the personal identification information of each of the persons is stored or not in connection with the assembly in the visitor storage portion.

6. The material distribution system according to claim 5, further comprising a material deletion portion for deleting the material of the assembly from the material storage portion if the attendance decision portion decides that nobody was absent from the assembly.

7. The material distribution system according to claim 3, wherein
the personal identification information input portion enters the personal identification information of a person who visits the assembly by reading it from an electronic recording medium carried by the person, and
the material output portion outputs the material of the assembly by printing it on paper if the person who visits the assembly wants a paper material and by writing the material of the assembly into the electronic recording medium carried by the person if the person wants electronic data.

8. A method for distributing a material, comprising the steps of:
storing the material in a material storage portion;
storing distribution target information that indicates persons to whom the material is permissible to be distributed in a distribution target storage portion;
entering personal identification information of a person who wants the material;
deciding whether the material is permissible or not to be distributed to the person who wants the material by comparing the entered personal identification information of the person with the distribution target information; and
outputting the material stored in the material storage portion for the person when it is decided that the material is permissible to be distributed to the person who wants the material.

9. The method according to claim 8, wherein the material is output by printing it on paper.

10. The method according to claim 8, wherein the material is output by writing it into the electronic recording medium carried by the person.

11. A method for distributing a material, comprising the steps of:
storing the material in a material storage portion;
storing distribution target information that indicates persons who need the material in a distribution target storage portion;
entering personal identification information of a person who wants the material;
deciding whether the person needs the material or not by comparing the entered personal identification information of the person with the distribution target information; and
outputting the material stored in the material storage portion for the person when it is decided that the person needs the material.

12. The method according to claim 11, wherein the material is output by printing it on paper.

13. The method according to claim 11, wherein the material is output by writing it into the electronic recording medium carried by the person.

14. A computer program product for use in a computer that performs a process for distributing a material, the computer program product makes the computer perform the process comprising the steps of:
accessing a material storage portion for storing the material;
accessing a distribution target storage portion for storing distribution target information that indicates persons to whom the material is permissible to be distributed;
entering personal identification information of a person who wants the material;
deciding whether the material is permissible or not to be distributed to the person who wants the material by comparing the entered personal identification information of the person with the distribution target information; and
outputting the material stored in the material storage portion for the person when it is decided that the material is permissible to be distributed to the person who wants the material.

15. A computer program product for use in a computer that performs a process for distributing a material, the computer program product makes the computer perform the process comprising the steps of:
accessing a material storage portion for storing the material;
accessing a distribution target storage portion for storing distribution target information that indicates persons who need the material;
entering personal identification information of a person who wants the material;
deciding whether the person needs the material or not by comparing the entered personal identification information of the person with the distribution target information; and
outputting the material stored in the material storage portion for the person when it is decided that the person needs the material.
